(19) United States
(12) Patent Application Publication
(10) Pub. No.: US 2026/0326741 A1
(43) Pub. Date: Oct. 22, 2026

(54) METHOD FOR ACTIVATING AT LEAST TWO ACTUATORS OF A MOTOR VEHICLE, MOTOR VEHICLE, CONTROL DEVICE FOR A MOTOR VEHICLE, AND METHOD FOR OPERATING A MOTOR VEHICLE

(71) Applicant: AUDI AG, Ingotstadt (DE)

(72) Inventors: Dr. Benjamin POPPINGA, Wettstetten (DE); Simon SEITLE, Oberhausen (DE)

(73) Assignee: AUDI AG, Ingotstadt (DE)

(21) Appl. No.: 19/158,369

(22) PCT Filed: Dec. 15, 2023
(86) PCT No.: PCT/EP2023/086106

§ 371 Date: Aug. 20, 2025

(30) Foreign Application Priority Data
Feb. 21, 2023 (DE) 102023104202.5

(51) Int. Cl. B60W 10/30; B60W 50/00

(52) U.S. Cl. CPC B60W 10/30; B60W 2050/0083

(57) ABSTRACT

An artificial intelligence configured to control actuators in a motor vehicle to provide a passenger compartment experience. If there are deviations from a target value for one actuator among the actuators, the target value may be adjusted for other actuators among the actuators so that the passenger compartment experience remains in accordance with target settings.

### CROSS-REFERENCE TO RELATED APPLICATIONS

This application is a U.S. national stage of International Application No. PCT/EP2023/086106, filed on Dec. 15, 2023, which claims the priority benefit of German Patent Application No. 10 2023 104 202.5 filed on Feb. 21, 2023. Both the International Application and the German Patent Application are incorporated by reference herein in their entirety.

### BACKGROUND

### 1. Field

An invention according to described examples relates to a method for controlling at least two actuators of a motor vehicle, in particular for the purpose of providing a passenger compartment experience. The invention according to the examples also relates to a motor vehicle in which the method according to the examples of invention can be carried out and a control unit intended for such a motor vehicle. The invention according to the examples further relates to a method for operating a motor vehicle, in particular for the purpose of providing a passenger compartment experience.

### 2. Description of the Related Art

Such vehicle passenger compartment experiences are offered to vehicle occupants when they are not engaged in the task of driving the motor vehicle. This can happen during a break or, in the case of an autonomous vehicle, during a journey wherein no person has to intervene to control.

A typical passenger compartment experience involves providing a feel-good atmosphere with the supply of warm air, actuating the seat heating, lighting experiences (especially with red light), relaxing music and the like.

From US 2018/0134116 A1, a motor vehicle is known with sensors that detect conditions prevailing inside and outside the motor vehicle. In order to create the best possible comfort for the vehicle occupant, a complex determination of input data (telephone, calendar, e-mail) is carried out to provide a complex actuator control (air supply in the vehicle, heating of the passenger compartment, humidification and dehumidification, lights, sound system, seat positions and seat heating). Machine learning is used for the complex determination.

From US 2021/0100480 A1, the recording of a user's position by means of artificial intelligence is also known, wherein measured values from several sensors are fed to the artificial intelligence.

When providing a passenger compartment experience or in other contexts in which several actuators of a motor vehicle are controlled together, the occupant themself may make changes to settings. For example, if they push their seat forward, the warm air supplied to the seat further back could become too hot, lights on displays could be perceived as too bright and the like.

### SUMMARY

Example objects of the invention according to described examples may be to make the control of actuators in a motor vehicle more flexible.

The example objects may be achieved by a method for controlling at least two actuators of a motor vehicle, by a motor vehicle, by a control unit, and by a method for operating a motor vehicle, with the features according to the claims.

The method according to the examples of the invention for controlling at least two actuators of a motor vehicle, in particular for the purpose of providing a passenger compartment experience, is carried out using artificial intelligence, wherein a target setting is specified for at least one predetermined actuator, which is assigned to a target value of a predetermined input variable, wherein if the actual value for the predetermined input variable differs from the target value, the artificial intelligence changes the target setting for at least one predetermined actuator.

The desired flexibility is achieved with this method: The method only has to be defined once, namely by specifying the target setting for the at least one predetermined actuator, but due to the use of artificial intelligence, the desired effect (passenger compartment experience) can be achieved as far as possible, even if the actual value for the predetermined input variable is not equal to the target value.

According to an example, a target setting is specified for at least two predetermined actuators, wherein the target setting of one actuator defines the target value of the predetermined input variable and wherein the artificial intelligence changes the target setting for the other predetermined actuator if the actual setting of the one predetermined actuator differs from the target setting for the one predetermined actuator.

In the example above, where the vehicle occupant has changed their seat position, the target seat position can define the target value of the predetermined input variable and the artificial intelligence can change the target settings for at least one other actuator depending on this, for example an actuator that emits light and/or an actuator that emits heat and/or an actuator that emits sound.

In an example, it is intended that a user can control at least some of the predetermined actuators in such a way that they depart from the target setting thereof. This would be the case with the seat. The artificial intelligence then changes the target setting for the other predetermined actuators that are not controlled by the user.

If, for example, the user does not want air that is too warm and turns down the ventilation, the red component in the light can be amplified to create a cozy passenger compartment experience (more red light-emitting diodes activated or the like).

According to another example of the invention, the predetermined input variable is a variable that reflects a user preference. This can directly influence the target setting of a single actuator, such as that for the seat, that for the volume of a sound-emitting device in a motor vehicle, that for the brightness of lights and the like. However, user preference can also be described in a more complex way, for example by a vector with a plurality of entries, where each entry in the vector is a target value for a different actuator. The predetermined input variable, which reflects user preference, can also simply be a parameter. The variable that reflects a user preference can also be determined with the help of sensors and artificial intelligence: For example, cameras and the like can be used to record the user's reactions to previous passenger compartment experiences which can then be evaluated by artificial intelligence.

It is possible that the predetermined input variable (for this purpose) is represented numerically. It may be that a user generally wants the light to be brighter than is dictated by the passenger compartment experience. Alternatively or additionally, a predetermined input variable can also be a logic variable. For example, the user can choose from several words (“warm”, “cozy”, “active”, “entertaining” and the like).

A binary input variable can also refer to situations outside the provision of the passenger compartment experience, such as driving the motor vehicle. It is known that a driver can set whether the driver drives more “sportily” or “economically” (fuel-saving).

According to another example, at least some, or, for example, all target settings can be changed by a user. This example differs from the one in which the user can physically depart from the target setting in that the present example allows the user to change the target settings as data/information, but then does not have to physically depart from these target settings. If they do depart therefrom, the artificial intelligence orients itself to the changed target setting. In this way, the user can specify their preferences in the perception of the passenger compartment experience.

According to another example, the predetermined input variable is a variable detected by at least one sensor, wherein the sensor is not affected by actuators. In contrast to the example described above, in which the user can control at least some of the predetermined actuators so that they depart from the target setting thereof and wherein the actual setting is then recorded, an environmental influence can be recorded in the example now in question. For example, the brightness outside the motor vehicle (daylight, fog, night) can define the target value of the predetermined input variable and thus also the target setting for at least one predetermined actuator. It is conceivable that this refers in particular to the brightness that is to be produced in the motor vehicle. For example, the starry sky captured by a camera as a sensor can also be displayed on a display/in the vehicle roof, so that the vehicle occupant gets the impression that the vehicle occupant is in the open air. In the same way, the camera as a sensor can detect other variables and control actuators accordingly. Furthermore, a microphone as a sensor that is not affected by actuators can detect the ambient volume and, depending on this, control sound-emitting actuators and other actuators differently than according to the original target setting. The artificial intelligence is able to determine all of this.

The motor vehicle according to the examples of the invention contains a control unit in which an artificial intelligence is implemented, in particular by a neural network of the control unit. The motor vehicle also contains actuators. A set with a plurality of parameter values specifies a plurality of target settings for predetermined actuators, wherein each target setting is assigned to a target value of a predetermined input variable and wherein the artificial intelligence is configured to change at least one parameter value of the set if an actual value for the predetermined input variable differs from the target value, and wherein the control unit is configured to control the actuators according to the changed set of parameter values. This motor vehicle implements the method for controlling at least two actuators as described above.

The control unit according to the examples of the invention for a motor vehicle of the kind just described contains a device for the provision of an artificial intelligence, for example a neural network, wherein a set with a plurality of parameter values that is stored in a memory of the control unit specifies a plurality of target settings for predetermined actuators, wherein at least one actuator and for example each target setting is assigned to a target value of a predetermined input variable and wherein the device is configured to provide an artificial intelligence of the control unit, to change at least one parameter value of the set if an actual value for the predetermined input variable differs from the target value, and wherein the control unit is configured to output control signals to actuators in accordance with the changed set of parameters.

The method according to the examples of the invention for operating a motor vehicle, for example for the purpose of providing a passenger compartment experience, is also carried out using artificial intelligence, wherein the method can be carried out in various motor vehicles either with or without a predetermined actuator. For at least one predetermined actuator, its presence or absence in the motor vehicle to be operated is determined. A set with parameter values defines a plurality of target settings for actuators, including the predetermined actuator, and, in the absence of the predetermined actuator in the vehicle, the artificial intelligence activates at least one other actuator and/or changes the parameter value for at least one other actuator compared to the target setting thereof. This method corresponds to the method described above for controlling at least two actuators, wherein the target value of the predetermined input variable indicates in a binary manner whether the respective actuator is present in the motor vehicle or not.

For use cases or application situations that may arise from the method and that are not explicitly described here, it may be envisaged that an error message and/or a request for user feedback is output in accordance with the method and/or a default setting and/or a predetermined initial state is set.

The examples according to invention also includes the control device for the motor vehicle. The control device may have a data processing device or a processor device that is set up to carry out the method according to the examples of the invention. For this purpose, the processor device may have at least a microprocessor and/or at least a microcontroller and/or at least an FPGA (Field Programmable Gate Array) and/or at least a DSP (Digital Signal Processor). Furthermore, the processor device may have program code which is set up to carry out the method according to the example of the invention when executed by the processor device. The program code can be stored in a data memory of the processor device. For example, a processor circuit of the processor device can have at least one circuit board and/or at least one SoC (System on a Chip).

The invention according to the examples also includes developments of the motor vehicle which have features as they have already been described in connection with the developments of the method according to the examples of the invention. For this reason, the corresponding developments of the motor vehicle according to the examples of the invention are not described again here.

The motor vehicle according to the examples of the invention is for example in the form of a motorized vehicle, for example a passenger car or truck, or a passenger bus or motorcycle.

As a further solution, the examples of the invention also include a computer-readable storage medium, containing commands which, when executed by a computer or a computer network, cause it to execute the method according to the examples of the invention. For example, the storage medium can be configured at least partly as a non-volatile data storage device (for example as a flash memory and/or as an SSD-solid state drive) and/or at least partly as a volatile data storage device (for example as a RAM-random access memory).

However, the storage medium can also be operated as a so-called Appstore server on the Internet, for example. The computer or computer network may provide a processor circuit with at least one microprocessor. The commands can be provided as binary code or assembler and/or as source code of a programming language (for example C).

The invention according to the examples also includes the combinations of the features of the described examples. Thus, the examples of the invention also include realizations, each of which has a combination of the features of several of the described examples, provided that the examples have not been described as mutually exclusive.

### BRIEF DESCRIPTION OF DRAWINGS

Examples of the invention are described below. In the figures:

FIG. 1 shows a motor vehicle in which the invention according to an example can be realized; and

FIG. 2 shows steps of a method according to an example of the invention.

### DESCRIPTION

The examples explained below are examples of the invention. In the case of the examples, the described components of the examples each represent individual features to be considered mutually independent, which also develop the examples of the invention independently of each other. Therefore, the disclosure is also intended to cover combinations of the features of the examples other than those presented. Furthermore, the examples described can also be supplemented by other features of the examples of the invention already described.

In the figures, the same reference signs denote functionally identical elements.

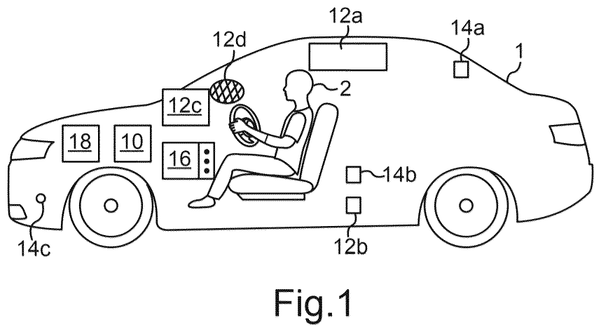

A motor vehicle shown in its entirety in FIG. 1 and designated 1 there is intended to provide an occupant 2 with a passenger compartment experience. For this purpose, there is a control unit 10, in which a device for the provision of an artificial intelligence is implemented by using a neural network. The control unit controls actuators 12a, 12b, 12c, 12d and receives signals from sensors 14a, 14b, 14c.

For example, first actuators 12a can be light-emitting diodes or other light sources in a band in the roof of the vehicle. One actuator 12b adjusts the seating position(s) of the seat of the vehicle occupant 2. A display 12c shows images and other representations, a loudspeaker 12d provides sound output. Other actuators can be involved (for example to provide heat such as seat heating and ventilation with hot air; humidifiers or dehumidifiers and much more).

A first sensor 14a is in the form of a camera that is directed at the surroundings of the motor vehicle, for example the sky above the motor vehicle. A second sensor 14b can detect the sitting position. This can be the result of a control of the actuator 12b by the control unit 10, and also indirectly due to an actuation by the vehicle occupant 2 on an input device 16 generally specified here. Another sensor 14c can detect temperature and/or humidity, for example. The vehicle occupant 2 can use the input device 16 to specify their user preferences, such as which temperature they prefer for the vehicle passenger compartment experience, whether they like to listen to particularly soft music or prefer to listen at a medium volume, and much more.

The method according to the examples of the invention includes that a set of parameter values is stored in the control unit 10 which is intended to define the passenger compartment experience. If necessary, this set can also be received wirelessly from an external unit (“backend”) via a communication interface 18. However, the set of parameter values cannot always perfectly indicate the passenger compartment experience. It may be that the intended target setting for an actuator is not possible at all, for example because the vehicle occupant 2 has made settings.

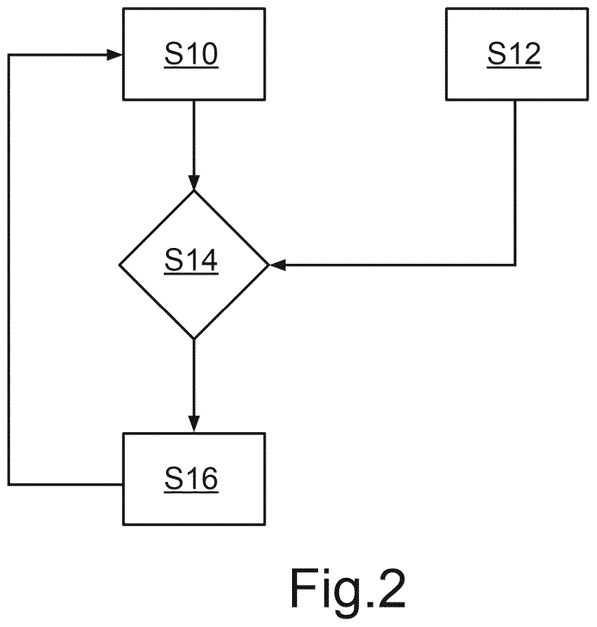

Accordingly, in FIG. 2, in step S12 the sensors can record the actual settings. In step S14 the target settings are compared with the actual settings. If there is a difference between the actual setting and the target setting, at least one parameter value is changed in step S16. For example, it may be that the vehicle occupant 2 has determined via the input device that the music should be played rather quietly. Then, instead of the intended rather white or red light, a discreet blue light (“night sky-like”) can be emitted by the actuators 12a. The artificial intelligence 10 ensures-if necessary after self-learning involving active feedback from the vehicle occupant 2 or recording their reaction with sensors-that the passenger compartment experience received by the vehicle occupant 2 is essentially as originally defined or only differs to the extent that it is based on actions of the vehicle occupant 2 (adjustment of the seat or other actuators, making entries at the input device 16).

After step S16, step S10 is usually returned to (if the passenger compartment experience is not terminated) and optionally repeated in parallel with step S12.

Overall, the examples show how an audio studio experience environment can be provided.

A description has been provided with particular reference to examples, but it will be understood that variations and modifications can be effected within the spirit and scope of the claims, which may include the phrase “at least one of A, B and C” as an alternative expression that refers to one or more of A, B or C, contrary to the holding in Superguide v. DIRECTV, 358 F3d 870, 69 USPQ 2d 1865 (Fed. Cir. 2004).

1.-10. (canceled)

11. A method of controlling at least two actuators, from among a plurality of actuators, of a motor vehicle, comprising:
storing, in a memory, for the at least two actuators, respectively, target settings which are assigned to target values of input variables, respectively; and
by a processor in communication with the memory and an artificial intelligence implemented based on a neural network,
if an actual setting of one actuator, from among the plurality of actuators, differs from a target setting, from among the target settings, changing, based on the artificial intelligence, a target setting, from among the target settings, for at least one other actuator from among the plurality of actuators.

12. The method as claimed in claim 11, wherein settings of at least a subset of actuators of the plurality of actuators are controllable by a user such that the settings of the subset of actuators controlled by the user deviate from target settings of the subset of actuators in the target settings, and
the method further comprises changing, based on the artificial intelligence, the target settings for other subset of actuators among the plurality of actuators not controlled by the user.

13. The method as claimed in claim 11, wherein a input variable among the input variables is a variable reflecting a preference of a user.

14. The method as claimed in claim 13, wherein the input variable is represented numerically.

15. The method as claimed in claim 11, wherein at least some target settings among the target settings are changeable by a user.

16. The method as claimed in claim 11, wherein an input variable among the input variables is a value detected by at least one sensor among a plurality of sensors not affected by the plurality of actuators.

17. A motor vehicle, comprising:
a control device in which artificial intelligence is implemented based on a neural network; and
a plurality of actuators, wherein
at least one set of actuators among the plurality of actuators have parameter values that are target settings for the plurality of actuators, respectively,
for at least some actuators of the plurality of actuators, the target settings are assigned to target values of input variables, respectively,
the artificial intelligence is configured to change at least one parameter value among the parameter values of the at least one set of actuators, if an actual value for an input variable among the input variables differs from a target setting among the target setting for the at least some actuators, and
the control device is configured to control the plurality of actuators according to the at least one parameter value changed.

18. A control unit for the motor vehicle as claimed in claim 17, comprising:
a processor;
a device configured to provide the artificial intelligence based on the neural network; and
a memory to store a plurality of parameter values that specify a plurality of target settings for the plurality of actuators, respectively,
wherein
for at least two actuators of the plurality of actuators, the plurality of target settings are assigned to target values of input variables, respectively,
the artificial intelligence is configured to change at least one parameter value among the plurality of parameter values of the at least one set of actuators if an actual value for an input variable among the input variables differs from a target value among the target values, and
the processor is configured to output control signals to the plurality of actuators according to the at least one parameter value changed.

19. A method of operating a motor vehicle, comprising:
determining presence or absence of at least one determined actuator among a plurality of actuators in the motor vehicle to be operated;
receiving, by a control device, a plurality of parameter values that define a plurality of target settings for the plurality of actuators, including the determined actuator, respectively; and
if, according to the determining, the determined actuator is not present in the motor vehicle, activating, by an artificial intelligence implemented based on a neural network, at least one other actuator among the plurality of actuators and/or changing a parameter value among the plurality of parameter values for at least one other actuator among the plurality of actuators compared to a target setting among the plurality of target settings for the at least one other actuator.
